(19) United States
(12) Patent Application Publication
(10) Pub. No.: US 2025/0349171 A1
(43) Pub. Date: Nov. 13, 2025

(54) Self-Service Interactive Terminal with Proactive Height Adjustment

(71) Applicant: 365 Retail Markets, LLC, Troy, MI (US)

(72) Inventors: Boris Amegadjie, Chicago, IL (US); Ryan McWhirter, Saint Clair Shores, MI (US)

(21) Appl. No.: 18/662,399

(22) Filed: May 13, 2024

(51) Int. Cl. G07F 9/00; G07F 9/02

(52) U.S. Cl. CPC G07F 9/009; G07F 9/001; G07F 9/023

(57) ABSTRACT

A self-service interactive terminal with proactive height adjustment is used with a product dispensing device for dispensing one or more products. The product dispensing device includes an interactive terminal. The interactive terminal is configured to display details associated with the one or more products and receive a selection of a product from the one or more products. A computing device is communicatively connected to the product dispensing device. The computing device is configured to detect a customer approaching the product dispensing device and adjust a height of the interactive terminal, prior to the selection of the product, to align with an approximate height of the customer. While the interactive terminal is at the adjusted height, the computing device processes a transaction based on the selection of the product causing the product dispensing device to dispense the product.

### TECHNICAL FIELD

This disclosure relates to self-service product dispensing systems, and, more specifically, to proactively adjusting the height of an interactive terminal upon detecting an approaching user of a self-service product dispensing system.

### BACKGROUND

Self-service markets have become increasingly popular in recent years due to a convergence of factors. Customer preferences are shifting towards convenience and speed, favoring on-demand options that minimize wait times. Simultaneously, advancements in technology including, but not limited to, reliable point-of-sale systems, secure payment processing, and inventory management software have made self-service models more viable for businesses. Additionally, the desire for contactless or low-contact transactions, accelerated by the COVID-19 pandemic, has further fueled the adoption of self-checkout and automated retail solutions. For businesses, these markets offer the potential for reduced labor costs and expanded hours of operation, making them an increasingly attractive proposition as customer and technological trends align. As such, self-service product dispensing systems are becoming increasingly prevalent, offering convenience and flexibility in retail, hospitality, and transportation settings, amongst others.

### SUMMARY

Disclosed herein are, inter alia, implementations of systems and techniques for proactively adjusting the height of an interactive terminal upon detecting an approaching user of a self-service product dispensing system.

In some implementations, a system as disclosed herein comprises a product dispensing device for dispensing one or more products and a computing device communicatively connected to the product dispensing device. The product dispensing device includes an interactive terminal configured to display details associated with the one or more products and receive a selection of a product of the one or more products. The computing device is configured to detect a customer approaching the product dispensing device, adjust a height of the interactive terminal to align with an approximate height of the customer prior to the selection of the product, and process a transaction based on the selection of the product to cause the product dispensing device to dispense the product while the interactive terminal is at the adjusted height.

In some implementations, a method as disclosed herein comprises detecting a customer approaching a product dispensing device for dispensing one or more products, adjusting, in response to detecting the customer approaching, a height of an interactive terminal attached to the product dispending device, to an approximate height of the customer, receiving, from the interactive terminal, a selection of a product of the one or more products, processing the selection of the product as a transaction; and dispensing the product.

In some implementations, an apparatus as disclosed herein comprises a memory subsystem and one or more processors configured to execute instructions stored in the memory subsystem to transmit, in response to a determination that a customer is approaching a product dispensing device, a first signal to the product dispensing device to cause the product dispensing device to adjust a height of an interactive terminal to align with an approximate height of the customer, wherein the interactive terminal is communicatively connected to the product dispensing device and the product dispensing device dispenses one or more products, receive, from the interactive terminal, a selection of a product from the one or more products, and transmit a second signal to the product dispensing device, in response to a completion of a transaction, causing the product dispensing device to dispense the product.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a self-service product dispensing system.

FIG. 2 is a block diagram of an example of an internal configuration of a computing device of a system for proactive height adjustment of an interactive terminal.

FIG. 3 is a block diagram of an example of a system of proactive height adjustment of an interactive terminal.

FIGS. 4A-B illustrate an example use case of a system for proactive height adjustment of an interactive terminal.

FIG. 5 is a swim lane diagram depicting operations performed using a system for proactive height adjustment of an interactive terminal.

FIG. 6 is an example of an interaction diagram for a system for proactive height adjustment of an interactive terminal.

FIG. 7 is an illustration of a graphical user interface (GUI) for display on an interactive terminal.

FIG. 8 is an example of a flowchart of a technique for proactive height adjustment of an interactive terminal.

### DETAILED DESCRIPTION

As self-service markets flourish, driven by convenience, technology, and changing customer habits, the demand for intuitive and accessible self-service product dispensing systems within them is also rising. Self-service product dispensing systems offer convenience and speed in various settings, from retail stores to transportation hubs. However, the reliance on fixed-height interactive terminals (e.g., kiosks) often creates challenges for customers of different statures. Children, individuals with disabilities, and even those of simply shorter or taller heights may struggle to comfortably reach buttons, view screens, or complete transactions. This lack of adaptability can lead to frustration, delays, and a sense of exclusion within the self-service experience. To address these limitations, a new approach is needed, one that prioritizes seamless, inclusive interactions for all users.

Conventional approaches to height-related accessibility issues have significant shortcomings. Some systems might offer a limited-range, manually adjustable terminal, placing the burden on the customer to find and operate the mechanism. This adds friction to the transaction and may still not accommodate the full spectrum of user heights. Others might provide a separate, lower terminal for accessibility, but this creates a segregated experience and can be costly to implement. Ultimately, these conventional methods fail to offer the automatic, inclusive solution that a truly user-centric product dispensing system demands.

Furthermore, self-service markets typically involve the use of a self-service kiosk or like device at which a customer may process a transaction for various consumable goods available at the self-service market. In some cases, there may be other devices located at and used with a self-service market, such as a product dispensing device configured to prepare and dispense products (e.g., beverages, such as coffee and coffee products). However, conventional approaches to such self-service systems often create a fragmented customer experience with disjointed interactions between product selection, payment, and retrieval stages between the self-service kiosk and the product dispensing device. That is, existing approaches are often inadequate, relying on separate terminals or potentially limited accessibility features that don't truly unify the self-service transaction process. This lack of integration can lead to customer confusion in the manner of completing a transaction, delays in transaction processing and product preparation, and thus decreased customer satisfaction.

Implementations of this disclosure that automatically detect and adjust to a height of the customer offer several key advantages. In particular, a self-service interactive terminal with proactive height adjustment is used with a product dispensing device for dispensing one or more products. The product dispensing device includes an interactive terminal. The interactive terminal is configured to display details associated with the one or more products and receive a selection of a product from the one or more products. A computing device is communicatively connected to the product dispensing device. The computing device is configured to detect a customer approaching the product dispensing device and adjust a height of the interactive terminal, prior to the selection of the product, to align with an approximate height of the customer. While the interactive terminal is at the adjusted height, the computing device processes a transaction based on the selection of the product causing the product dispensing device to dispense the product.

The implementations disclosed herein improve accessibility through the use of sensor and adjustment technologies. For example, the systems and techniques of this disclosure may use camera systems with image processing, proximity sensors, or other technologies such as pressure-sensors, radar or the like. This sensor data helps estimate the height of the customer and triggers an automated adjustment mechanism. An interactive terminal, mounted on a motorized track, arm, or the like, can physically reposition itself to align with the approximate height of the customer. This removes barriers for customers of varying heights, including children, those with disabilities, and simply individuals of shorter or taller stature. The proactive adjustment eliminates unnecessary steps and delays, streamlining the entire interaction. Customers no longer need to search for manual adjustments or wait for staff assistance. This efficiency makes the self-service experience smoother and more convenient.

Moreover, the interactive terminal is connected to one or more product dispensing devices, thereby directly improving customer convenience in self-service market environments by linking the operations of the involved devices and thus streamlining several key stages of the transaction. The interactive terminal becomes the central hub for product discovery, selection, customization, and payment processing. This unified interface minimizes the need for the customer to navigate between separate stations or devices. Additionally, by linking the interactive terminal and the product dispensing device(s), customers potentially benefit from clear instructions on product retrieval, ensuring they efficiently receive their purchased items. This integration simplifies the self-service experience, creates a more straightforward and satisfying journey for the customer, and demonstrates sensitivity to diverse user needs. A system with these features fosters a sense of inclusivity, making all customers feel valued, comfortable, and capable of using the self-service market.

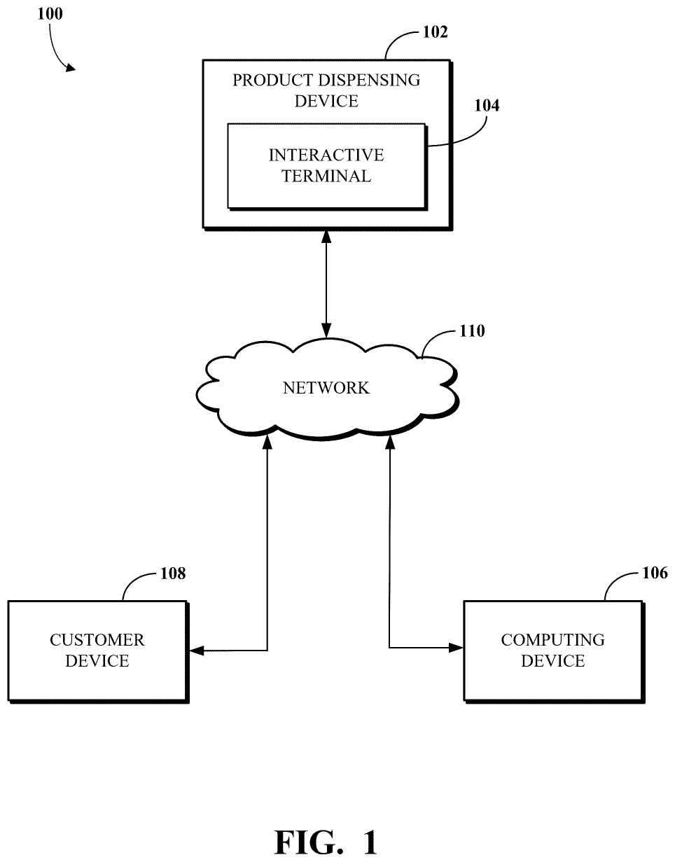

To describe some implementations in greater detail, reference is first made to examples of hardware structures which may be used. FIG. 1 is a block diagram of an example of a self-service product dispensing system 100. The system 100 includes a product dispensing device 102 that dispenses a product upon the completion of a transaction. The product dispensing device 102 includes an interactive terminal 104 for selecting a product to be dispensed. In one non-limiting example, the interactive terminal 104 may include options to select different types of coffee (i.e., a coffee product) to be dispensed. For example, the interactive terminal 104 may be or otherwise include a touchscreen interface configured to simultaneously output visual data representative of various product options dispensable at the product dispensing device 102 and receive input indicative of a selection of one of those product options by a user of the product dispensing device 102.

The product dispensing device 102 may be a refrigerated unit or a non-refrigerated unit. The product dispensing device 102 may in some cases include a locking mechanism, for example, to prevent access to a product retrieval space (i.e., a portion of the product dispensing device 102 or of an area in which it is located) until a transaction for a subject product has been completed. While the implementations of this disclosure are generally described with respect to beverages that are prepared and dispensed into a drinking cup by the product dispensing device 102, in some cases, additional or alternative products may be used with the product dispensing device 102. For example, the interactive terminal 104 may enable the selection of single-serving snack packages (e.g., chips, cookies, and crackers).

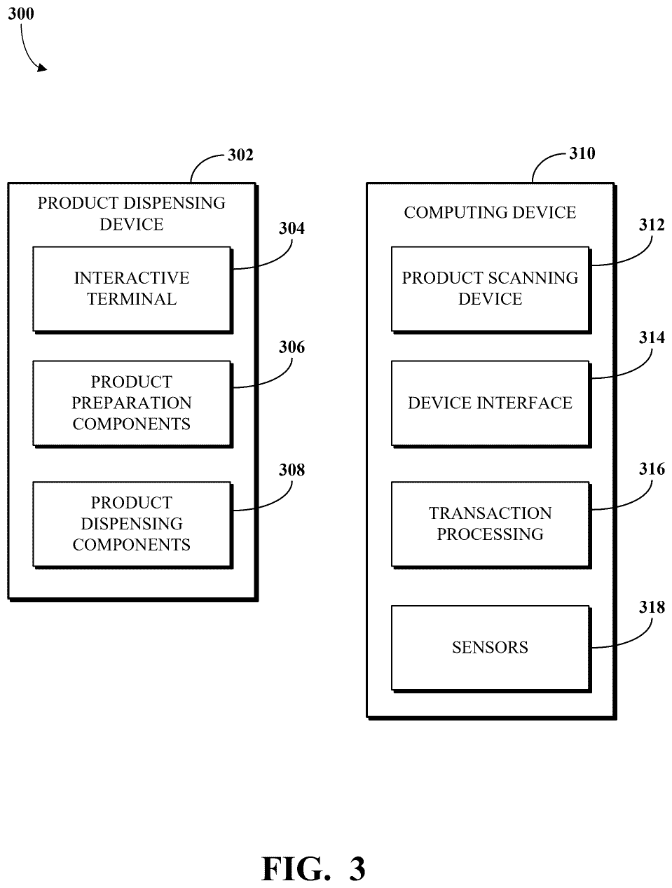

The system 100 includes a computing device 106 communicatively connected to the product dispensing device 102 and that facilitates a transaction associated to one or more products. The computing device 106 at least includes a memory, a processor, and a network interface. The memory is configured to store instructions executable by the processor to enable a customer to purchase one or more products. The processor is configured to execute the instructions stored in the memory. The network interface is configured to communicate output of the processing or other data to one or more other devices, for example, one or more of the product dispensing device 102 or a customer device 108. For example, the computing device 106 may execute, interpret, call, or otherwise run transaction processing software, such as further disclosed with respect to FIG. 3.

In particular, the computing device 106 performs operations for detecting a customer) approaching the product dispensing device 102, adjusting the height of the interactive terminal 104 based on the approximate height of the approaching customer, receiving a product selection from the product dispensing device 102 based on a product selection from the interactive terminal 104, and processing a transaction based on the selection of the product causing the product dispensing device 102 to dispense the product.

The customer device 108 is a computing device used by a customer who selects a product at the interactive terminal 104. For example, the customer device 108 may be a mobile device (e.g., a smartphone) running a mobile application or a web application (e.g., via a web browser) at which information associated with a user account registered for purchasing products from the product dispensing device 102 can be viewed. The customer device 108 may receive alerts related to products dispensed for the customer from the product dispensing device 102 or transactions processed in connection with product dispensed for the customer from the product dispensing device 102.

In some implementations, the customer device 108 can significantly enhance the transaction experience with the product dispensing device 102. This may begin by associating the customer device with an account of the customer. The association may be accomplished through a mobile application on the customer device 108, a web application linked to the product dispensing device 102, or the like. The customer device 108 and the product dispensing device 102 may establish the connection using technologies such as a quick response (QR) code, near field communication (NFC) for wireless communication, entering a unique code displayed by the product dispensing device 102 into the dedicated application on the customer device 108, or the like.

Once connected, the mobile application on the customer device 108 offers additional features for product selection, customization, and payment. The mobile application may act as an extension of the interface of the interactive terminal 104, allowing the customer to browse and customize choices. Payment can be securely processed directly through the mobile application, potentially using pre-stored customer payment details. Finally, the mobile application may provide real-time notifications to the customer device 108, including order status updates, estimated wait times, and an alert when the product is dispensed and ready for collection.

In some implementations the customer device 108 may be omitted altogether. In this case, the customer would engage directly with the interactive terminal 104 attached to the product dispensing device 102 to complete a transaction. The interface of the interactive terminal 104 may allow for product browsing, selection, and any necessary customization of the order. To facilitate payment, the interactive terminal 104 may offer several options, including but not limited to accepting cash, credit/debit cards, or supporting contactless payment methods. Upon successfully processing the payment, the system 100 can provide clear instructions or visual cues (displayed on the interactive terminal 104) directing the customer to the designated location for retrieving the dispensed product.

The computing device 106 communicates with the one or more of the product dispensing device 102 or the customer device 108 over a network 110. The network 110 can be or include, for example, the Internet, a local area network (LAN), a wide area network (WAN), a virtual private network (VPN), or another public or private means of electronic computer communication capable of transferring data between network-connected devices.

In some cases, there may be multiple ones of the product dispensing device 102 in a retail store or other retail area. For example, a self-service convenience store area in an office building may include a first product dispensing device that dispenses refrigerated products and a second product dispensing device that dispenses non-refrigerated products. In another example, a retail store (e.g., a self-service retail store) may include tens of product dispensing devices arranged throughout the store. Generally, where there are multiple ones of the product dispensing device 102 in a given store or area, each of the product dispensing devices may include or otherwise use its own separate computing device 106. However, in some implementations in which there are multiple ones of the product dispensing device 102 in a given store or area, a single computing device 106 may be shared between some or all of the multiple product dispensing devices 102 rather than each product dispensing device 102 including or otherwise using its own separate computing device 106. For example, a single computing device 106 may be configured to process sensor output produced at each of multiple product dispensing devices according to information specific to the subject merchandiser device and to communicate the processed data, individually or in a batch, to one or more devices, as disclosed above.

Regardless of a number of the product dispensing device 102 in a given store or area, in some implementations, the computing device 106 may be an integrated circuit, (e.g., an application-specific integrated circuit (ASIC)), a field-programmable gate array (FPGA), a system-on-a-chip (SoC), or another special purpose device. For example, the computing device 106, as an ASIC, FPGA, or SoC, may be configured to perform some or all the functionality disclosed herein. In some such implementations, the computing device 106 may be configured to process a transaction based on the product selection from the product dispensing device 102 and transmit a transaction confirmation a device over the network 110, such as the customer device 108. For example, the customer device 108, may in such a case be a mobile device (e.g., cellphone, smartphone, etc.) associated with a customer.

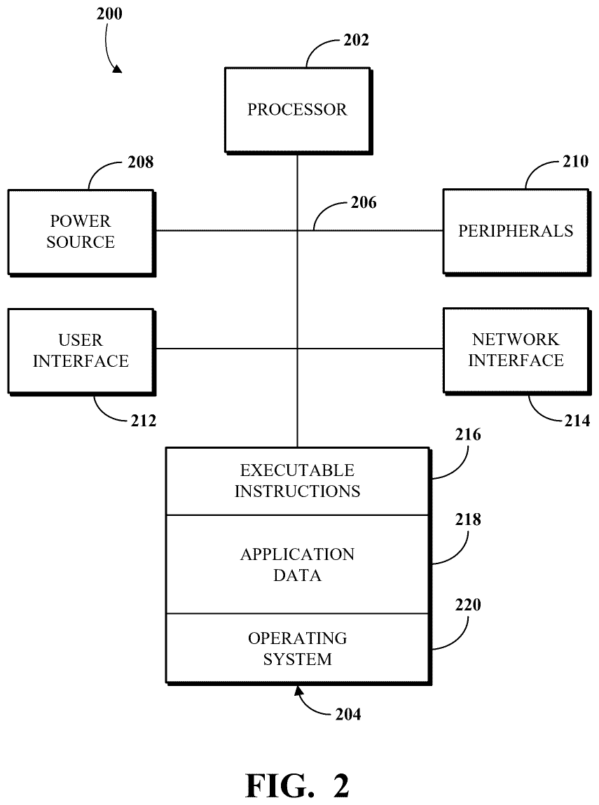

FIG. 2 is a block diagram of an example of an internal configuration of a computing device 200 of a system for proactive height adjustment of a self-service interactive terminal such as the system 100 shown in FIG. 1. The computing device 200 may, for example, be the computing device 106 or the customer device 108 shown in FIG. 1. The computing device 200 includes components or units, such as a processor 202, a memory 204, a bus 206, a power source 208, peripherals 210, a user interface 212, and a network interface 214. One of more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, now existing or hereafter developed, configured for manipulating or processing information. For example, the processor 202 can include multiple processors interconnected in any manner, including hardwired or networked, including wirelessly networked. For example, the operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory of the memory 204 can be random access memory (RAM) (e.g., a DRAM module, such as DDR SDRAM) or another form of volatile memory. In another example, the non-volatile memory of the memory 204 can be a disk drive, a solid state drive, flash memory, phase-change memory, or another form of non-volatile memory configured for persistent electronic information storage. The memory 204 may also include other types of devices, now existing or hereafter developed, configured for storing data or instructions for processing by the processor 202.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. The operating system 220 can be, for example, Microsoft Windows®, Mac OS X®, or Linux®; an operating system for a small device, such as a smartphone or tablet device; or an operating system for a large device, such as a mainframe computer.

The power source 208 includes a source for providing power to the computing device 200. For example, the power source 208 can be an interface to an external power distribution system. In another example, the power source 208 can be a battery, such as where the computing device 200 is a mobile device or is otherwise configured to operate independently of an external power distribution system.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network, for example, a local area network, a wide area network, a machine-to-machine network, a virtual private network, or another public or private network. The network interface 214 can be a wired network interface or a wireless network interface. The computing device 200 can communicate with other devices via the network interface 214 using one or more network protocols, such as using Ethernet, TCP, IP, power line communication, Wi-Fi, Bluetooth®, infrared, GPRS, GSM, CDMA, Z-Wave, ZigBee, another protocol, or a combination thereof.

Implementations of the computing device 200 may differ from what is shown and described above with respect to FIG. 2. In some implementations, the computing device 200 can omit the peripherals 210. In some implementations, the memory 204 can be distributed across multiple devices. For example, the memory 204 can include network-based memory or memory in multiple clients or servers performing the operations of those multiple devices. In some implementations, the application data 218 can include functional programs, such as a web browser, a web server, a database server, another program, or a combination thereof.

FIG. 3 is a block diagram of an example of a system 300 for proactive height adjustment of a self-service interactive terminal. The system 300 includes a product dispensing device 302 and a computing device 310. The product dispensing device 302 may, for example, be or be similar to the product dispensing device 102 of FIG. 1. The computing 310 device may, for example, be or be similar to the computing device 106 of FIG. 1. The product dispensing device 302 includes an interactive terminal 304 for selecting a product to be dispensed, product preparation components 306 for preparing the product to be dispensed, and product dispensing components for dispensing the prepared product. The interactive terminal 304 may be or be similar to the interactive terminal 104 of FIG. 1.

The interactive terminal 304 serves as the primary interface between a customer and the system 300. It features a display, which may be a touchscreen, for presenting product information, options, and pricing details to the customer. The interactive terminal 304 includes a user interface configured to receive and process input (e.g., touch controls, buttons, voice recognition, etc.) enabling the customer to intuitively select a product. The interactive terminal 304 may be attached (i.e., coupled) to a track mechanism such that the track mechanism allows for vertical adjustments of the interactive terminal 304. The track mechanism may consist of a fixed rail or channel which can be mounted to the product dispensing device 302. The interactive terminal 304 may be fitted with a sliding or rolling component that engages with the track, enabling smooth movement along the vertical axis. The track mechanism may include a motorized system controlled by the computing device 310, enabling the automatic height adjustments, of the interactive terminal 304, based on sensor inputs as described in more detail below. Alternatively, the track mechanism may be manually operated, with a customer-accessible lever or handle to reposition the interactive terminal 304.

The product preparation components 306 enable the transformation of components (e.g., ingredients or pre-packaged items) into the final product that is dispensed to the customer by preparing the components in one or more ways. The specific nature of these components will vary depending on the type of product the product dispensing device 302 dispenses. For example, in a coffee (e.g., coffee product) dispensing system, the product preparation components 306 can include one or more of a grinder for coffee beans, a water heater or steamer, brewing mechanisms, reservoirs for milk or flavorings, or the like. In another example, the product preparation components 306 may include a refrigerated storage area for pre-packaged snacks or beverages.

The product dispensing components 308 work in tandem with the product preparation components 306 to physically deliver the final product to the customer. The product dispensing components 308 can include a dispensing outlet, which can be a nozzle, cup holder, a retrieval area, or the like. The product dispensing components 308 can incorporate mechanisms like pumps, valves, conveyors, and/or the like to control the flow and release of the product from the product dispensing device 302. In some implementations, the product dispensing components might also ensure proper packaging or labeling of the dispensed product.

The computing device 310 includes a product scanning device 312 for scanning a product to be associated with a transaction, a device interface 314 for communication with the computing device 310, transaction processing software 316 for processing the transaction, and sensors 318 for detecting events. The product scanning device 312 enables additional products to be associated with the transaction beyond the products selectable through the interactive terminal 304. The product scanning device 312 could be a barcode scanner, a QR code reader, a radio-frequency identification (RFID) reader, or the like depending on the implementation. Scanning the code of a product with the product scanning device 312 associates the scanned product with the current transaction. This enables combining pre-packaged items with dispensed products in a single transaction. The scanned product information is transmitted through the device interface 314 to the transaction processing software 316 for proper pricing and inclusion in the final transaction.

For example, a customer using the interactive terminal 304 might select a beverage via an onscreen menu. The customer may also desire a pre-packaged bag of chips that is not directly selectable on the interactive terminal 304. In this case, the product scanning device 312 can be utilized to associate the pre-packaged bag of chips to the current transaction. The customer can locate the barcode on the chip bag and scan it with the product scanning device 312. The product scanning device 312 transmits the product information (i.e., a unique identifier for the product) through the device interface 314 to the transaction processing software 316.

The device interface 314 serves as a communication hub for the computing device 310. The device interface 314 facilitates the exchange of data between the various components within the system 300. The device interface 314 handles communication with the interactive terminal 304, receiving customer selections, transmitting product information, and adjusting the height of the interactive terminal 304. The device interface 314 also interacts with the product scanning device 312 associating the scanned product data with the transaction. Additionally, the device interface 314 communicates with the product dispensing components 308, relaying commands to initiate the dispensing processes. In some implementations, the device interface 314 may communicate with a device associated with the customer, such as the customer device 108 of FIG. 1. In some implementations, the device interface 314 can communication with external entities (e.g., entities not included within the system 300) to enable connections with payment processing systems to finalize transactions or connect with network servers for data transfer or updates. By acting as the central communication channel, the device interface 314 ensures smooth operations and data exchange between the computing device 310 and other entities either internal or external to the system 300.

The transaction processing software 316 serves as the central engine for handling purchases within the system 300. Upon receiving a product selection from the interactive terminal 304 and/or a scanned item from the product scanning device 312, the transaction processing software 316 retrieves product information, pricing details, and potentially applicable taxes. The transaction processing software 316 then calculates the total transaction amount and interacts with the device interface 314 to facilitate payment processing. This may include connecting with external payment systems for credit card transactions, debit card swiping, or contactless payment methods. Once payment is confirmed, the transaction processing software 316 transmits signals through the device interface 314 to initiate the product dispensing process via the product dispensing device 302. The transaction processing software 316 can keep track of inventory levels and communicate with network servers to update product databases or send transaction logs. The transaction processing software 316 enables orchestration of the financial exchange and product dispensing process, ensuring a smooth and secure customer experience.

The sensors 318 enable the system 300 to automatically adjust the height of the interactive terminal 304. The sensors 318 can include or otherwise use (or be used with) various technologies depending on the specific implementation. For example, the sensors 318 can include cameras using image recognition software configured to detect a customer approaching the product dispensing device 302. Alternatively, or in addition to, the sensors can include proximity sensors (e.g., ultrasonic sensors, infrared sensors, etc.) usable to detect the presence of a customer within a designated zone (e.g., within a threshold range of the product dispensing device 302). In either case, the sensors 318 provide information for the computing device 310 to determine the presence of a customer and estimate the approximate height of the customer. The approximate height of the customer is then used to trigger the automatic adjustment mechanism (as described above) to position the interactive terminal 304 at a height suitable for the approaching customer.

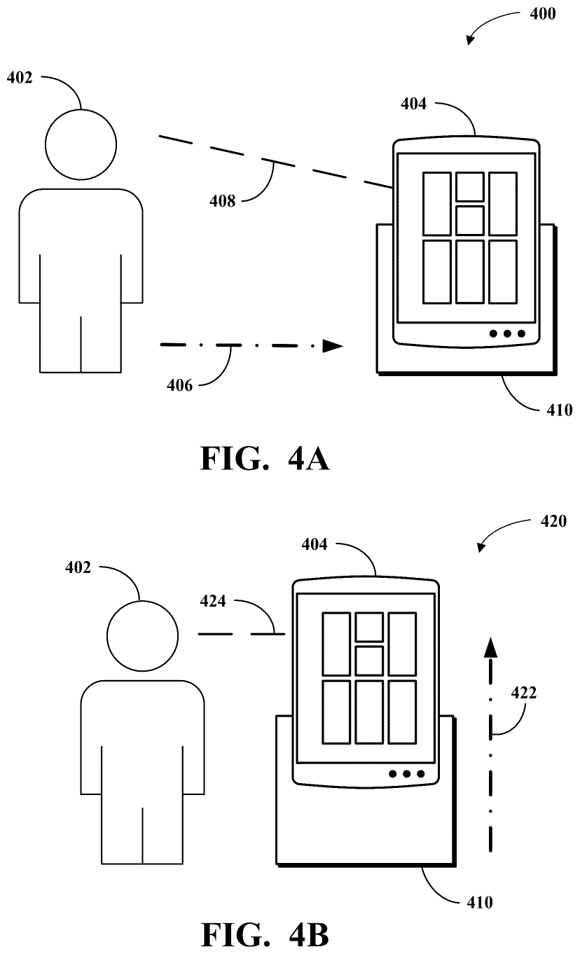

FIGS. 4A and 4B illustrate an example use case of a system for proactive height adjustment of an interactive terminal 404. The system may be or be similar to the system 300 of FIG. 3. The interactive terminal 404 may be or be similar to the interactive terminal 304 of FIG. 3. The interactive terminal 404 is mounted to a product dispensing device 410. The product dispensing device 410 may be or be similar to the product dispensing device 302 of FIG. 3. The interactive terminal 404 is depicted as a display screen with a user interface (e.g. touchscreen).

FIG. 4A depicts a scene 400 that includes the interactive terminal 404 in a lower position, representing a default height of the interactive terminal 404 or the adjusted position from a previous customer. The presence of the customer 402 and directionality are illustrated by the movement line 406. As the customer 402 approaches the interactive terminal 404 the system detects the approximate height of the customer 402 (as described in detail below). Based on the approximate height of the user and the anticipated sight line 408 (i.e., the viewing angel from the customer 402 to the interactive terminal 404) the system determines that the current height of the interactive terminal 404 would not be ideal for the customer 402.

FIG. 4B depicts a scene 420 after the system has adjusted the height of the interactive terminal 404 based on the approximate height of the customer 402. The interactive terminal 404 is shown in a raised position as indicated by the adjustment line 422. This new position of the interactive terminal 404 provides an ideal sight line 424 for the customer 402 to view and interact with the user interface of the interactive terminal 404.

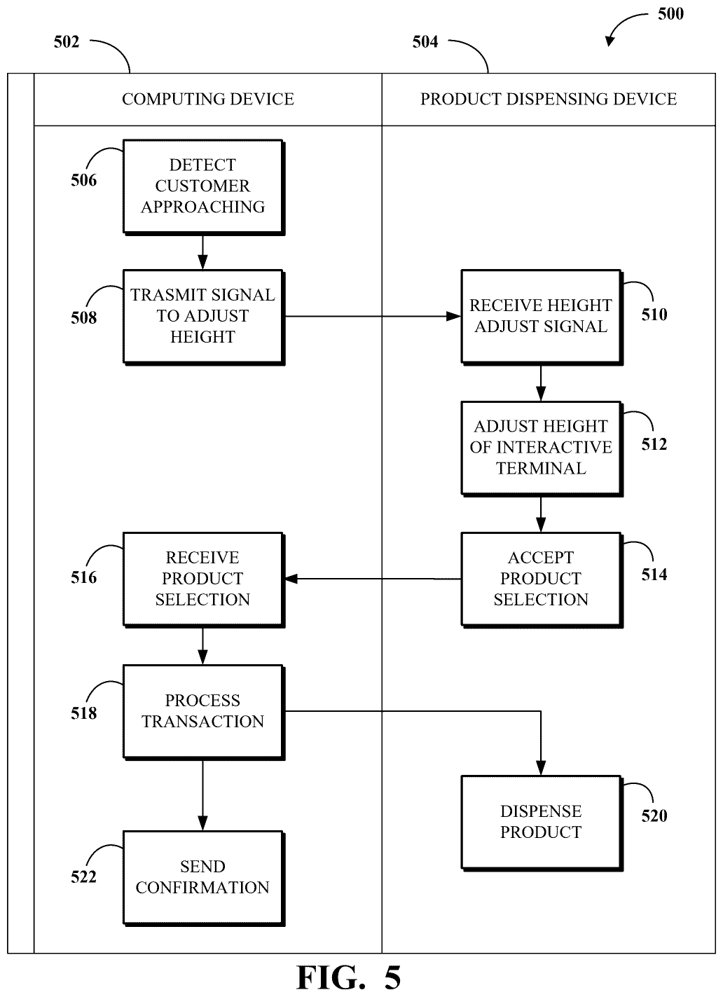

FIG. 5 is a swim lane diagram 500 depicting operations performed using a system for proactive height adjustment of an interactive terminal. The system may be the same or similar to the system 300 of FIG. 3. The interactive terminal may be or be similar to the interactive terminal 404 of FIG. 4. The diagram 500 depicts the interactions between the computing device 502 and the product dispensing device 504. The computer device may be or be similar to the computer device 310 of FIG. 3. The product dispensing device 504 may be or be similar to the product dispensing device 410 of FIG. 4.

At 506, the computing device 502 detects a customer approaching the product dispensing device 504. The customer is detected by the computing device 502 utilizing one or more sensors (such as the sensors 318 of FIG. 3) integrated within or associated with the system itself. The types of sensors can include cameras, proximity sensors or any combination thereof. For example, the system may use camera-based detection with one or more cameras and image processing software to identify a human figure and its direction of movement. The image processing software may be configured to analyzes successive images captured by the one or more cameras, detect a human figure within the image and determine that the human figure is moving towards the product dispensing device 504. In some implementations, the image processing software may include using a machine learning model trained to identify objects that stand out from the background environment. The image processing software may use the machine learning model to distinguish and classify these objects. The classification may focus specifically on recognizing human figures based on characteristic shapes, proportions, and potentially even movement patterns.

Once the image processing software identifies a human figure, the image processing software starts tracking the position of the human figure across successive images. If the human figure appears to grow progressively larger in successive images, this indicates that the human figure is moving towards the product dispensing device 504. To increase accuracy the system might utilize additional cameras to create a more comprehensive 3D representation of the scene.

The software may also analyze the ratio between the height of the human figure in pixels compared to known reference objects within the image to estimate the height of the approaching customer. The reference objects may be elements of the product dispensing device 504, nearby structures, or even standard-sized items deliberately placed within the field of view of the camera (e.g., floor tiles, pillars, display signs, etc.). By comparing the height of the detected human figure in pixels to the known dimensions of these reference objects, the image processing software can derive a proportional estimation of the actual height of the customer.

Alternatively, proximity sensors, such as infrared or ultrasonic sensors, can be used to detect a customer within a pre-defined proximity of the product dispensing device, indicating the approach of the customer. In some implementations, both camera-based detection and proximity sensors can be used together. In some implementations other sensors such as pressure-sensitive floor regions or radar-based systems can be used to achieve customer detection. Regardless of the specific implementation, the computing device 502 can use any combination of sensors to detect the approach of the customer.

At 508, the computing device 502 transmits a signal to the product dispensing device 504 to adjust the height of the interactive terminal. That is, upon the computing device 502 determining the need for a height adjustment, based on the detected customer, the computing device 502 transmits a signal to the product dispensing device 504. The signal instructs the product dispensing device 504 to initiate the height adjustment mechanism for the interactive terminal. The signal can be communicated between the computing device 502 and the product dispensing device 504 via a wired or wireless connection. For example, the signal can be communicated to the product dispensing device 504 via a wired connection using a simple electrical current or a more complex digital message. A wired connection can be accomplished using a physical cable to establish a direct link between the computing device 502 and the product dispensing device 504. The physical cable can carry simple electrical signals for basic adjustments; for example, a pulsed high/low signal might signify “adjust upwards” or “adjust downwards”. Alternatively, a wire connection can use a standard wired communication protocol like RS-232 or USB. Using a standard wired communication protocol allows for transmitting more complex messages potentially specifying the exact target height of the terminal. Regardless of the specific signaling format, a wired connection offers advantages in terms of reliability and potential resistance to interference compared to wireless solutions.

In some implementations, the signal can be communicated to the product dispensing device 504 using a wireless protocol such as Bluetooth or Zigbee. When using a wireless communication technique, the computing device 502 and the product dispensing device 504 can be equipped with compatible wireless transceivers. A short-range wireless protocol like Bluetooth, Zigbee, or another wireless protocol suitability for device-to-device communication can be utilized. The signal transmitted can contain instructions to move the interactive terminal upwards or downwards or can include a specific target height. Implementing a wireless connection protocol provides advantages in terms of system design flexibility. Utilizing wireless protocols eliminates the need for physical cabling between devices, simplifying installation and maintenance procedures.

At 510, the product dispensing device 504 receives the height adjustment signal from the computing device 502. The height adjustment signal contains instructions regarding the desired adjustments to be made to the position of the interactive terminal. The product dispensing device 504 includes a receiver or transceiver compatible with the chosen communication method (i.e., wired, wireless). Upon receiving the signal, internal circuitry or software within the product dispensing device 504 decodes the instructions. Based on the information contained in the signal, the product dispensing device 504 activates the adjustment mechanism. The mechanism can include an electromechanical system with a motor, gears, or other components designed to physically move the interactive terminal along a track.

At 512, the height of the interactive terminal is adjusted. In some implementations the product dispensing device 504 includes a track mechanism to guide the motion of the interactive terminal. This track could be mounted vertically on the product dispensing device 504 or a nearby structure. The interactive terminal can then be attached to this track via a sliding or rolling component. Upon receiving the adjustment signal, the product dispensing device 504 activates an integrated motor or actuator to drive the mechanism. The direction and extent of the movement (upwards or downwards) is dictated by the instructions within the received signal (i.e. the height adjustment signal). The automatic height adjustment enables dynamically positioning the interactive terminal to an approximate height that aligns with the approaching customer, providing an enhanced customer experience.

At 514, a product selection is accepted. That is, the customer makes a product selection via the interactive terminal. The GUI of the interactive terminal presents a graphical display of available products, which can include, but is not limited to, images, descriptions, and pricing information. The customer can interact with the interface using touch controls, physical buttons, voice commands or the like. Upon the customer selecting a product (e.g., selecting a coffee beverage from the menu), the selection is registered by the product dispensing device 504 and sent to the computing device 502 to be associated with a transaction.

At 516, the product selection is received by the computing device 502. The product selection is received by the computing device 502 through a device interface (such as the device interface 314 of FIG. 3) which facilitates data exchange between the various components. Upon the customer selecting a product (e.g., tapping a “Latte” button on the touchscreen), the interactive terminal transmits a corresponding signal or data packet to the computing device 502. The signal identifies the selected product and includes relevant options or customizations chosen by the customer. For example, after selecting “Latte” from the beverage menu of the interactive terminal, the customer can select several other options or customizations appropriate for a “Latte.” The customer can be prompted to select a size (e.g., small, medium, large, etc.), a milk type (e.g., whole, low-fat, almond, soy, etc.), flavorings (e.g., vanilla, caramel, hazelnut, etc.), sweetness level, temperature (e.g., hot, iced, etc.), or the like. The GUI of the interactive terminal can guide the user through the relevant options and upon completion, send the selected product to the computing device 502.

At 518, the computing device processes the transaction. The transaction can be processed using transaction processing software (such as the transaction processing software 316 of FIG. 3). Processing the transaction can be separated into multiple steps. First, the computing device 502 retrieves information about the selected product. The information can be retrieved from an internal data store or from an external data store. The information includes, but is not limited to, product name, description, price, and inventory levels. Next, the computing device 502 calculates the total transaction amount based on the retrieved product information and any selected options or customizations (e.g., size, flavorings, etc.). The calculation can include applying relevant sales tax and/or other fees.

Once the total transaction amount is calculated, the computing device 502 can initiate secure communication with a payment processing gateway, connecting to a credit card network, a mobile payment platform, or the like. The customer interacts with the GUI of the interactive terminal to provide payment information (e.g., swiping a card, entering a PIN, using contactless payment, etc.). Upon successful payment confirmation from the payment gateway, the transaction can be considered complete. Finally, the computing device 502 can update an inventory database, internal or external, to reflect the purchased product. Updating the inventory database helps maintain accurate stock levels and can be used to trigger alerts for product restocking.

After the transaction is successfully processed, the computing device 502 can send confirmation to the product dispensing device 504. At 520, the product dispensing device 504 dispenses the product. Upon receiving a signal confirming the completed transaction for the selected product from the computing device 502 the product dispensing device 504 engages the product preparation components (such as the product preparation components 306 of FIG. 3) and the product dispensing components (such as the product dispensing components 308 of FIG. 3). For example, in a coffee (i.e., coffee products) dispensing system, this can include activating a grinder, engaging a brewing mechanism, coordinating component (e.g., milk or flavoring) systems, and finally dispensing the finished beverage into an appropriate cup or container. In a pre-packaged snacks or beverage dispensing device, the product dispensing device 504 can use a retrieval mechanism such as a robotic arm, a conveyor belt, controlled release compartments, or the like to deliver the selected product to a designated pickup area.

At 522, a confirmation is sent to a mobile device associated with the customer. Sending the confirmation message relies on the customer associating a mobile number with the current transaction. The association mechanism can include direct number entry at the interactive terminal, QR code scanning, integration with a dedicated app, or the like. The confirmation message, delivered via SMS, push notification, email, or the like, can include, but is not limited to, order details (e.g., products, total cost, etc.) a provide a pickup code, a preparation time estimate, or directions to the dispensing location.

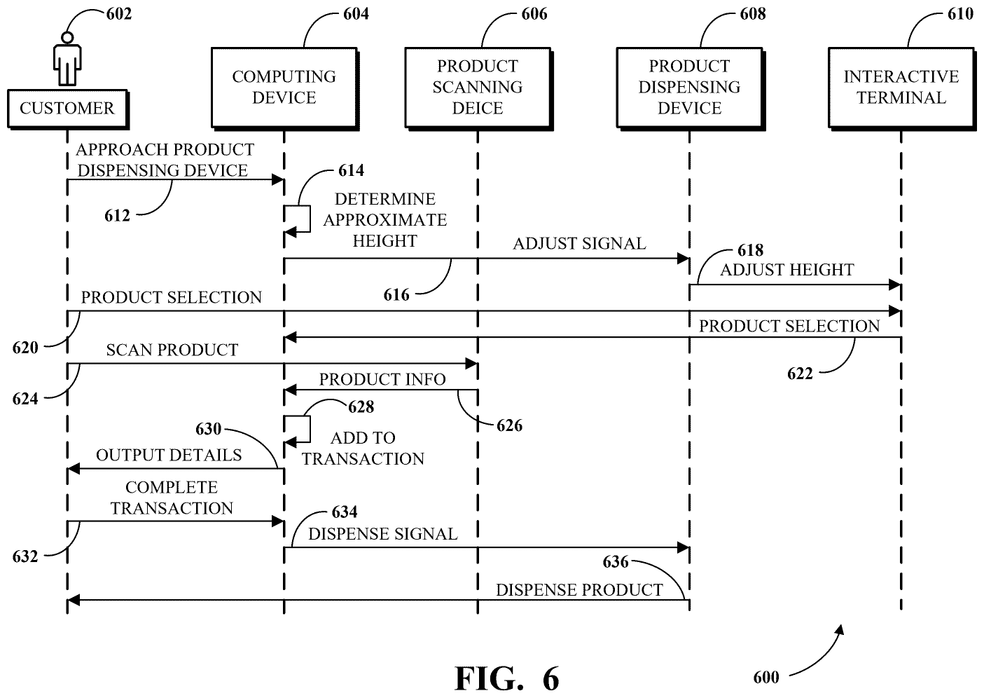

FIG. 6 is an example of an interaction diagram 600 for a system for proactive height adjustment of an interactive terminal 610. The interactive diagram 600 includes a customer 602, a computing device 604, a product scanning device 606, a product dispensing device 608, and an interactive terminal 610. The computing device 604 may be or be similar to the computing device 502 of FIG. 5. The product scanning device 606 may be or be similar to the product scanning device 312 of FIG. 3, the product dispensing device 608 may be or be similar to the product dispensing device 504 of FIG. 4, the interactive terminal 610 may be or be similar to the interactive terminal 404 of FIG. 4.

At 612, the customer 602 approaches the computing device 604. The computing device 604 can detect the approach of the customer 602 as described in reference to 506 of FIG. 5. At 614, the computing device 604 determines an approximate height of the customer 602. The computing device 604 can determine the approximate height of the customer based on input received from various types of sensors (such as the sensors 318 of FIG. 3). The computing device 604 may use camera sensors combined with image processing software to capture and analyze images of the customer 602 approaching. The computing device can determine the approximate height of the customer 602 based on the relative position of the customer in relation to known reference points in the environment (e.g., floor, base of the dispensing device, etc.). In some implementations, the computing device 604 can use multi-cameras or depth-sensing technology to create a more accurate 3D representation of the customer 602 and increase the efficiency of the height estimation.

At 616, a height adjustment signal is sent to the product dispensing device 608. The height adjustment signal can be or be similar to the signal transmitted from the computing device 502 to the product dispensing device 504 at 508 of FIG. 5. Upon receiving the height adjustment signal from the computing device 604 at 618, the product dispensing device 608 adjusts the height of the interactive terminal 610. The height adjustment may be or be similar to the height adjustment at 512 of FIG. 5.

At 620, the customer 602 selects a product using the interactive terminal 610. The customer 602 can select a product using the interactive terminal 610 in a manner that is or is similar to that one described in reference to 514 and 516 of FIG. 5. At 622, the interactive terminal 610 sends the product selection to the computing device 604. The computing device 604 receives the product selection in a manner that is or is similar to the one described in reference to 516 of FIG. 5.

At 624, the customer 602 scans a product, that is not selectable using the interactive terminal 610, using the product scanning device 606. In other words, the customer 602 can associate a product with the current transaction that is not directly selectable through the main menu of the interactive terminal 610. The product scanning device 606 provides this flexibility. The customer 602 can locate the barcode or other machine-readable identification (e.g., a QR code or RFID tag, etc.) of the product and scan the product. By scanning the barcode with the product scanning device 606, the product information is transmitted to the computing device 604. At 616, the computing device 604 can retrieve details like product name, price, and inventory status from a data store, as described above in reference to 518 of FIG. 5, using the scanned barcode. At 628, the scanned product is associated with the current transaction for the customer 602, Additionally, the details about the scanned product can be displayed using the GUI of the interactive terminal 610.

At 630, the details about the transaction are output to the customer 602. The details can be displayed using the GUI of the interactive terminal 610 or the details can be sent to a customer device (such as the customer device 108 of FIG. 1) associated with the customer 602. For example, the details can be a summary of the transaction. The summary can include, but is not limited to, a list of selected products and/or scanned products with their names, quantities, and prices, as well as the total cost of the transaction. In some implementations, an estimated wait time or instructions for pickup can be provided.

At 632, the transaction is completed (i.e., finalized). Completing the transaction can include, but is not limited to, receiving confirmation from the customer 602 that the transaction is accurate (i.e., correct, without error), accepting and processing payment for the transaction as described above in reference to 518 of FIG. 5, updating inventory and sending a confirmation to the customer device. Upon completion of the transaction, the computing device 606, at 634, sends a dispense signal to the product dispensing device 608. The dispense signal may be or be similar to the signal confirming the completed transaction as described in reference to 520 of FIG. 5. Once the product dispensing device 608 receives the dispense signal from the computing device 606, the product dispensing device 608 dispenses the product as described in reference to 520 of FIG. 5.

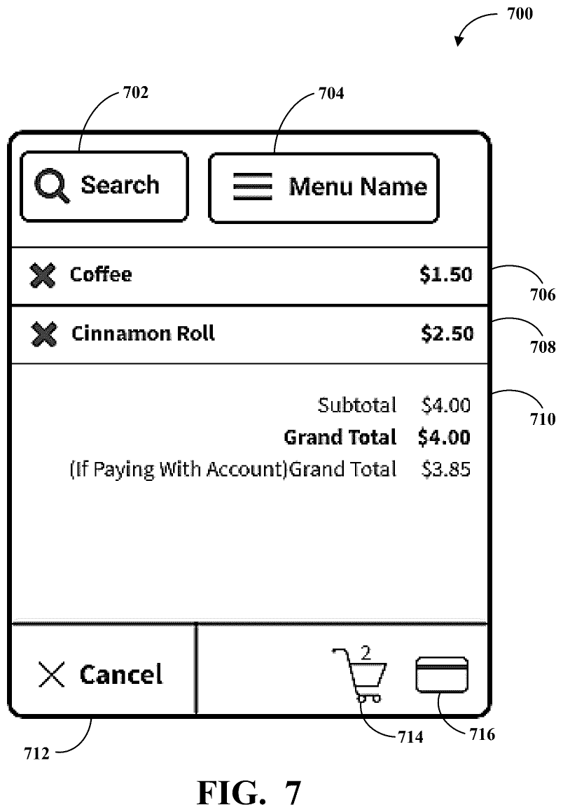

FIG. 7 is an illustration of a GUI 700 for display on an interactive terminal. The interactive terminal may be or be similar to the interactive terminal 610 of FIG. 6. The GUI 700 includes a search button 702, a menu button 704, a line item 706, a line item 708, a summary section 710, a cancel button 712, a view cart button 714, and a checkout button 716. The search button 702 offers a customer a direct method for finding specific products. Upon tapping or clicking the search button 702, the GUI 700 can transition to a search interface. The search interface can include, but is not limited to, a text input field allowing the customer to enter keywords or product names. The results can be presented in a list format or as dynamic suggestions as the customer types. The search can include features such as autocomplete, search by category, or filters for narrowing down results based on price, dietary restrictions, or other relevant criteria.

The menu button 704 provides the customer with an alternative path for exploring the available products. Pressing the menu button 704 can reveal a structured menu system, or a set of product categories and subcategories. The menu can be presented in a drop-down or expandable list format, or as a full-screen display with visual aids and product descriptions. The organization of the menu may depend on the type of product dispensing system. For example, a coffee (e.g., coffee product) dispensing device can have categories for hot coffee beverages, cold coffee beverages, and specific coffee varieties.

The line item 706 and the line item 708 represent products that have been selected for purchase by the customer. Each line item displays essential information about the product, such as the name of the product and the price. In some implementations, the relevant quantity of each product (not shown) can be shown on the line item. In some implementations, the line items might include additional details (not shown), such as any selected customizations (e.g., size upgrades, flavoring choices, etc.). The line items can also include interactive elements that allow the customer to edit or remove selected products.

The summary section 710 presents the customer with a clear overview of the current transaction (i.e., order). The summary section 710 calculates and displays the total cost of the selected products. The summary section 710 can also display a breakdown of the total by including applicable sales taxes, discounts, or any additional fees charged. In some implementations, the summary section 710 can provide information regarding estimated preparation time or instructions for retrieving the dispensed product (e.g., a pickup code).

The cancel button 712 enables cancelling the current transaction. Upon tapping or clicking on the cancel button 712, the customer may be prompted to confirm the intention to cancel (i.e., abandon) the order. If confirmed, all the selected products and the data associated with the selected product can be removed from the GUI 700.

The view cart button 714 provides the customer with a detailed breakdown of the current selected and/or scanned products before finalizing the transaction. Tapping or clicking on the view cart button 714 transitions the GUI 700 to a dedicated cart screen. The dedicated cart screen can display an expanded view of the line items including, but not limited to, product images, selected customizations (sizes, flavors), prices, and quantity adjustment controls. The dedicated cart screen can provide options for applying discounts or promo codes or provide an overview of applicable loyalty program benefits associated with the customer.

The checkout button 716 initiates the final steps of the transaction process. Upon tapping or clicking on the checkout button 716, the selected products and their associated details can be confirmed. The confirmation can be performed via the customer using confirmation screen presented within the GUI 700. If payment is required, a secure payment input interface can be displayed. The secure payment input interface can collect credit and/or debit card information, provide options for contactless payment methods (e.g., mobile wallet), or allow for payment using a stored customer account. Once payment is successfully processed, the transaction is completed (i.e., finalized), and the product dispensing process is initiated. The GUI 700 may display a confirmation message and potentially send details of the completed order to a mobile device associated with the customer (such as the customer device 108 of FIG. 1).

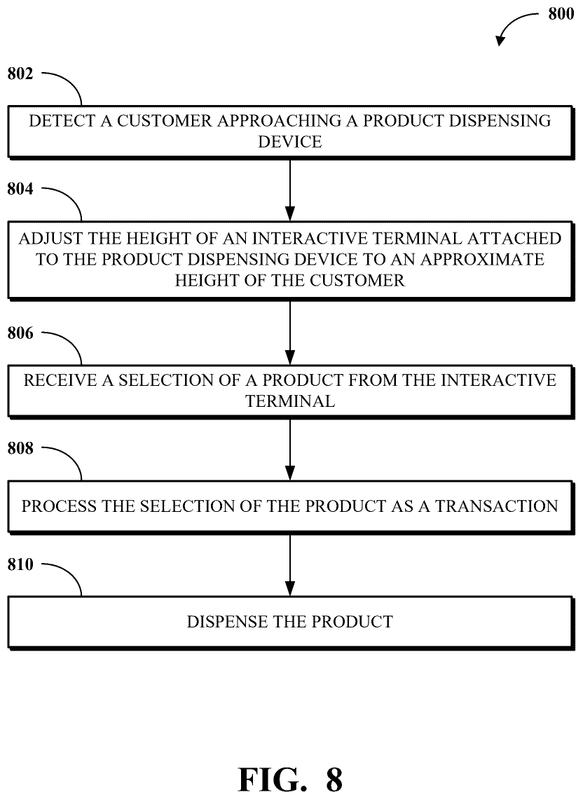

FIG. 8 is an example of a flowchart of a technique 800 for proactive height adjustment of an interactive terminal. The technique 800 can be executed using computing devices, such as the systems, hardware, and software described with respect to FIGS. 1-7. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations of the technique 800 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 802, a customer is detected approaching a product dispensing device. The customer may be or be similar to the customer 602 of FIG. 6. The product dispensing device may be or be similar to the product dispensing device 608 of FIG. 6. The detection relies on one or more sensors, such as cameras with image recognition software, proximity sensors (e.g., infrared, ultrasonic), or, in some implementations, pressure-sensitive floor regions or radar-based systems as discussed in more detail above in relation to 506 of FIG. 5.

At 804, the height of an interactive terminal attached to the product dispensing device is adjusted to an approximate height of the customer. In other words, the height of the interactive terminal attached to the product dispensing device is automatically adjusted in response to detecting an approaching customer. The interactive terminal may be or be similar to the interactive terminal 610 of FIG. 6. The adjustment mechanism performs height adjustment processes including estimating the height of the customer using sensor data (such as from the sensors 318 of FIG. 3), calculating the adjustment for the interactive terminal, and physically repositioning the terminal via a motorized system mounted on a track, adjustable arm, or the like.

At 806, a selection of a product from the interactive terminal is received. That is, input indicating the selection of a product by a customer is received from the interactive terminal. The selection process enables the customer to choose a desired item from the available offerings (i.e., products). The interface of the interactive terminal can present a graphical display of products, including names, images, descriptions, and pricing details. The customer can interact with this interface to browse and make a selection. The interactive terminal can accommodate various form of input including, but not limited to, touchscreen, buttons, voice recognition, or the like as described in more detail above in reference to the interactive terminal 304 of FIG. 3.

At 808, the selection of the product is processed as a transaction. The transaction may be processed by the transaction processing software 316 of FIG. 3. Processing the transaction can include, but is not limited to, receiving confirmation that the transaction is accurate (i.e., correct, without error), accepting and processing payment for the transaction, updating inventory, and sending a confirmation to a customer device (such as the customer device 108 of FIG. 1) as described in reference to 632 of FIG. 6 above.

At 810, the product is dispensed. That is, the selected product is dispensed to the customer upon confirmation that the transaction has been completed. The product can be dispensed using product preparation components in conjunction with product dispensing components (such as the product preparation components 306 and the product dispensing components 308 of FIG. 3). In some implementations, the product to be dispensed can be a beverage. In this case, the product dispensing device can activate pumps, valves, mixers, heating and/or cooling elements according to the selected product. The finished product can be dispensed into a cup or other suitable container. In some implementations, the product to be dispense can be a pre-packaged item, as such a retrieval mechanism (e.g., robotic arm, conveyor belt, controller release compartment, etc.) can be used to deliver the pre-package product to a designated pickup area as described above in reference to 520 of FIG. 5.

The implementations of this disclosure can be described in terms of functional block components and various processing operations. Such functional block components can be realized by any number of hardware or software components that perform the specified functions. For example, the described implementations can employ various integrated circuit components (e.g., memory elements, processing elements, logic elements, look-up tables, and the like), which can carry out a variety of functions under the control of one or more microprocessors or other control devices. Similarly, where the elements of the described implementations are implemented using software programming or software elements, the systems and techniques can be implemented with any programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques could employ any number of conventional techniques for electronics configuration, signal processing or control, data processing, and the like. The words “mechanism” and “element” are used broadly and are not limited to mechanical or physical implementations, but can include software routines in conjunction with processors, etc.

Likewise, the terms “mechanism,” “module,” or “monitor” as used herein and in the figures may be understood as corresponding to a functional unit implemented using software, hardware (e.g., an integrated circuit, such as an ASIC), or a combination of software and hardware. In certain contexts, such mechanisms, modules, or monitors may be understood to be a processor-implemented software mechanism, processor-implemented software module, or software-implemented monitor that is part of or callable by an executable program, which may itself be wholly or partly composed of such linked mechanisms, modules, or monitors.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively, or in addition, the memory subsystem may include data or instructions that are hard-wired into processing circuitry.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While this disclosure has been described in connection with certain implementations, it is to be understood that this disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system, comprising:
a product dispensing device for dispensing one or more products, wherein the product dispensing device includes an interactive terminal configured to:
display details associated with the one or more products; and
receive a selection of a product of the one or more products; and
a computing device communicatively connected to the product dispensing device and configured to:
detect a customer approaching the product dispensing device;
adjust, prior to the selection of the product, a height of the interactive terminal to align with an approximate height of the customer; and
process, while the interactive terminal is at the adjusted height, a transaction based on the selection of the product to cause the product dispensing device to dispense the product.

2. The system of claim 1, wherein to process the transaction includes to:
transmit a signal from the computing device to the product dispensing device; and
initiate, by the product dispensing device, dispensing the selection of the product.

3. The system of claim 1, wherein to adjust the height of the interactive terminal includes to:
move the interactive terminal from a first position to a second position, wherein the first position is below the second position.

4. The system of claim 1, wherein to adjust the height of the interactive terminal includes to:
move the interactive terminal from a first position to a second position, wherein the first position is above the second position.

5. The system of claim 1, wherein the interactive terminal is coupled to a track mechanism and the track mechanism allows for vertical adjustments of the interactive terminal.

6. The system of claim 1, wherein the computing device is configured to:
transmit a confirmation of the transaction to a mobile device associated with the customer.

7. The system of claim 1, wherein the product dispensing device is a coffee dispensing device and the one or more products are one or more coffee products that are prepared by the product dispensing device.

8. The system of claim 1, wherein the computing device includes a product scanning device and is further configured to:
scan, using the product scanning device, a second product that is separate from the one or more products; and
include the second product in the transaction.

9. A method, comprising:
detecting a customer approaching a product dispensing device for dispensing one or more products;
adjusting, in response to detecting the customer approaching, a height of an interactive terminal attached to the product dispending device, to an approximate height of the customer;
receiving, from the interactive terminal, a selection of a product of the one or more products;
processing the selection of the product as a transaction; and
dispensing the product.

10. The method of claim 9, comprising:
transmitting a confirmation of the transaction to a mobile device associated with the customer.

11. The method of claim 9, comprising:
adding, using a product scanning device, a second product to the transaction, wherein the second product is separate from the one or more products.

12. The method of claim 9, wherein adjusting the height of the interactive terminal comprises:
changing a position of the interactive terminal from a first position to a second position, wherein the first position is below the second position.

13. The method of claim 9, wherein adjusting the height of the interactive terminal comprises:
changing a position of the interactive terminal from a first position to a second position, wherein the first position is above the second position.

14. The method of claim 9, wherein processing the selection of the product as a transaction comprises:
transmitting a signal to the product dispensing device, wherein the signal causes the product dispensing device to initiate dispensing the product.

15. An apparatus, comprising:
a memory subsystem; and
one or more processors configured to execute instructions stored in the memory subsystem to:
transmit, in response to a determination that a customer is approaching a product dispensing device, a first signal to the product dispensing device to cause the product dispensing device to adjust a height of an interactive terminal to align with an approximate height of the customer, wherein the interactive terminal is communicatively connected to the product dispensing device and the product dispensing device dispenses one or more products;
receive, from the interactive terminal, a selection of a product from the one or more products; and
transmit a second signal to the product dispensing device, in response to a completion of a transaction, causing the product dispensing device to dispense the product.

16. The apparatus of claim 15, comprising:
a product scanning device, wherein the one or more processors are further configured to execute instructions to:
scan, using the product scanning device, a second product that is separate from the one or more products; and
include the second product in the transaction.

17. The apparatus of claim 15, wherein one or more processors are further configured to execute instructions to:
transmit a confirmation of the transaction to a mobile device associated with the customer.

18. The apparatus of claim 15, comprising:
one or more sensors, wherein to determine that the customer is approaching the product dispensing device includes instructions to:
receive data from the one or more sensors indicating a presence and a directionality of the customer; and
determining, based on the presence and the directionality of the customer, that the customer is approaching the product dispensing device.

19. The apparatus of claim 18, wherein at least one of the one or more sensors is a camera.

20. The apparatus of claim 18, wherein the first signal includes an approximate height of the customer.
